(19) United States
(12) Patent Application Publication
(10) Pub. No.: US 2006/0190137 A1
(43) Pub. Date: Aug. 24, 2006

(54) Chemometric modeling software

(75) Inventor: Steven W. Free, St. Peters, MO (US)

Correspondence Address: THOMPSON COBURN, LLP, ONE US BANK PLAZA, SUITE 3500, ST LOUIS, MO, 63101, US

(73) Assignee: Steven W. Free

(21) Appl. No.: 11/061,909

(22) Filed: Feb. 18, 2005

(51) Int. Cl. G05D 11/00

(52) U.S. Cl. 700/266

(57) ABSTRACT

A method for integrating chemometric model development and chemometric model application to a process system, the method comprising: (1) receiving spectral data from a process system, the received spectral data corresponding to material being monitored by the process system; (2) receiving user input through at least one graphic user interface; (3) developing at least one chemometric model at least partially in response to the received user input; and (4) applying at least one chemometric model to the received spectral data to thereby predict a property of the material being monitored; and wherein the developing step and the applying step are performed by an integrated software program. Systems and software related to this method are also disclosed herein.

### FIELD OF THE INVENTION

This invention relates generally to chemometric analysis of materials and, more particularly, to using an integrated computer program to develop and run chemometric models related to pharmaceutical manufacturing.

### BACKGROUND OF THE INVENTION

During the manufacture of an active pharmaceutical ingredient (API) by a process system, the materials in the process system undergo a series of chemical reactions that necessarily alter the composition of the materials in the process system. For instance, on occasion, the process system is cleaned. Typically, the cleaning process begins with the introduction of a cleaning solvent, or agent, into the process system. The solvent is then circulated to draw into solution any residual API in the process system. As the solvent reaches saturation with the API, its ability to draw the API into solution diminishes thereby creating a need to replace the solvent with fresh fluid. At some point, the amount of residual API decreases until it is no longer able to saturate a fresh batch of solvent. The cleaning may proceed beyond this point with new solvent being introduced to draw the concentration of the API in the system even lower and, eventually, to a level such that the process system can be declared “clean” and therefore ready for a new manufacturing run. Other process occur within the manufacture of pharmaceutical products, such as blending and drying operations, in which the composition of the final materials may be altered.

Similar dynamic composition changes occur in many other process systems not limited to the pharmaceutical industry. For instance, process systems such as petroleum product transport systems (i.e. pipelines) typically carry any number of products during their service life. During one interval a particular pipeline might be used to deliver kerosene and during the next interval it might be used to deliver light-sweet crude oil. Because the user of the latter delivered crude oil neither wants nor can use the kerosene, it is desirable to determine when the leading edge of the crude oil arrives at the delivery point or at an appropriate branch in the pipeline.

Thus, in many process systems, it is desirable to sense the composition of a material or a complex combinations of materials in an instantaneous, or nearly instantaneous, (e.g., in “real-time”) manner. The ability to sense the composition allows the user of the process system to determine how well the process system is performing its intended function (e.g., the creation of a pure API) and to control the process system (e.g., opening and closing valves to route a product to the correct tank). One method of sensing the composition of material is by way of using a spectrometer to measure spectra of the material and deriving the material's composition from the measured spectra. Spectra may be optical spectra including electromagnetic energy in the ultraviolet, visible, near infrared or infrared regions of the electromagnetic spectrum, but are not limited to such.

Theoretically, the spectra convey to the observer all of the information needed to know the composition of the material and, therefore, the current status of the process system (e.g. the reaction has begun or has reached completion). In reality, as is well known, many factors complicate the derivation of the composition from the spectra. These complications include the presence of constituents in the material with overlapping spectra; the presence of constituents which are partially or completely opaque at key wavelengths; and resolution and sensitivity limitations of the data gathering system. Nonetheless, the observer will choose one or more features of the spectra that indicate the property of the material in which the observer is interested. For a simple example, the presence of absorption at a particular wavelength may uniquely indicate that a particular constituent is present.

For the complex spectra typically encountered in process systems, though, it is often desirable to use chemometric modeling to de-convolve the data gathered from the spectra in order to derive the properties of interest to the observer. Optical spectra may be used for this purpose, but the chemometric modeling may be used to analyze any data which can be similarly represented (e.g., a particle size distribution). Unfortunately, the currently available chemometric modeling software applications are awkward and inconvenient to use (i.e., the applications are user-unfriendly). Typically, the existing applications require the user to collect or prepare a large number of samples, gather representative spectra associated with each, and then analyze each sample in a laboratory setting to determine the property of interest of each sample with great accuracy. Next, the user must build a separate spreadsheet or otherwise enter this data into the program that contains the spectral data for the samples along with the analytically determined properties of the samples. The user then builds the chemometric model by selecting a number of the spectra for processing with the intent being to mathematically (e.g., statistically) correlate the monitored spectra with selected properties. Using the remaining spectra, the user then validates the model by running it on the remaining unused spectra, thereby generating predictions of the property or properties of the associated samples. A comparison of the predicted and analytically determined properties reveals the model's quality (i.e. how “good” the model is at making accurate predictions). If the comparison reveals that the model is not sufficiently accurate, the model must be modified or rebuilt from scratch. Upon generating a sufficiently accurate model, the user then saves the model in a file. Subsequently, to apply this model to an actual process system the user manually loads, or imports, the saved model into an analyzer for real-time prediction of the impurity concentrations for a material within the process system being monitored. Thus, the model must be built in one application and then imported into a different application to be used. Furthermore, many chemometric modeling programs do not support real-time prediction of properties.

If differences exist between the spectrometer used to obtain the calibration spectra and the spectrometer used to monitor the process system, however, it is likely that the model will need further modification to produce results that are sufficiently accurate for controlling or monitoring a real-time process system. Those skilled in the art of chemometric analysis understand that building the model requires a great deal of judgment based on the user's subjective understanding of the sample spectra, the system, and the various models that the user could build. Accordingly, the user expends a significant amount of time and labor developing and modifying the model. Then, in addition, the user must again transfer the modified model to the real-time application. In the meantime, the process system either lies idle (thereby wasting capital) or produces sub-optimal product.

Thus a need exists to streamline the manner in which chemometric models of spectral data are built and modified and then used in real-time applications.

### SUMMARY OF THE INVENTION

It is in view of the above problems that the present invention was developed. The invention provides methods, systems, and computer readable media for performing chemometric modeling of spectral data gathered from a monitored material, and predicting material properties in real-time.

In a first preferred embodiment the present invention provides an integrated computer application that uses the same processing engine for developing a chemometric model and for using the chemometric model to predict values in real-time. The application interfaces with a desktop environment and a real-time environment. From the desktop environment, the application accepts user inputs for building the model. In contrast, from the real-time environment, the application accepts spectral data from a process system in which the material of interest is being monitored. Also, the application uses the chemometric model and the real-time spectral input to predict a property of the material (e.g. the concentration of an API or the type of fuel in the pipeline).

Also disclosed herein is a method for integrating chemometric model development and chemometric model application to a process system, the method comprising: (1) receiving spectral data from a process system, the received spectral data corresponding to a material being monitored by the process system, (2) receiving user input through at least one graphic user interface, (3) developing at least one chemometric model at least partially in response to the received user input, and (4) applying at least one chemometric model to the received spectral data to thereby predict a property of the material being monitored, and wherein the developing step and the applying step are performed by an integrated (common) software program. Preferably, the spectral data are received from the process system in real-time. Further still, the at least one chemometric model is preferably applied to the received spectral data in real-time to thereby predict one or more properties of the material being monitored.

In response to a predicted property, the method may further comprise the step of controlling the process system at least partially in response to the predicted property. This controlling step may include controlling an amount of the material being monitored that is introduced into the process system at least partially in response to the predicted property or of starting or stopping a new step in the process.

The method may also comprise the step of displaying at least one feedback graphic user interface on a user computer, the at least one feedback graphic user interface being configured to provide a user of the user computer with real-time feedback as to a quality of the at least one applied chemometric model. Further still, the method may also comprise the step of displaying at least one chemometric model modification graphic user interface on the user computer, the at least one chemometric model modification graphic user interface being configured to receive input from the user that corresponds to a modification of the at least one chemometric model being applied to the received spectral data, and wherein the user input receiving step comprises receiving chemometric model modification input from the user through the at least one chemometric model modification graphic user interface. Moreover, the method may further comprise the step of applying, in response to user input, the modified chemometric model to the received spectral data to thereby predict a property of the material being monitored. User input can also control the navigation between the at least one feedback graphic user interface and the at least one chemometric model modification graphic user interface (e.g., to or from such GUIs).

Further still, the method may also comprise the steps of (1) retrieving from a memory or storage medium at least one of a plurality of chemometric models that are stored in the memory, and (2) providing the at least one retrieved chemometric model to at least one of the group consisting of the developing step and the applying step.

Also disclosed herein is a computer readable medium for performing this method. In such an embodiment, the computer readable medium preferably comprises: (1) a code segment for execution by a processor and configured to receive spectral data, the received spectral data corresponding to the materials being monitored in a process system, (2) a code segment for execution by a processor and configured to develop at least one chemometric model at least partially in response to user input received via at least one graphical user interface, and (3) a code segment for execution by a processor and configured to apply at least one chemometric model to the received spectral data to thereby predict a property of the material being monitored.

Further features and advantages of the present invention, as well as the structure and operation of various embodiments of the present invention, are described in detail below with reference to the accompanying drawings.

### BRIEF DESCRIPTION OF THE DRAWINGS

The accompanying drawings, which are incorporated in and form a part of the specification, illustrate the embodiments of the present invention and together with the description, serve to explain the principles of the invention. In the drawings:

FIG. 1 illustrates a material process system constructed in accordance with the principles of the present invention;

FIG. 2 illustrates a control loop constructed in accordance with the principles of the present invention;

FIG. 3 is a block diagram of a computer program of a preferred embodiment of the present invention;

FIG. 4 illustrates a method in accordance with the principles of the present invention;

FIG. 5 illustrates a graphic user interface constructed in accordance with a preferred embodiment; and

FIGS. 6a to 6f illustrate exemplary graphic use interfaces for chemometric model building and modification.

### DETAILED DESCRIPTION OF THE PREFERRED EMBODIMENTS

Subtle variations exist between the manner in which different chemometric models predict material properties from spectral data. Because of these subtle variations, a model derived from a different model or from data from a different stream or process system would be less accurate than one derived from the process system stream to be monitored. Thus, standard models have been unreliable in the past.

The preferred embodiment comprises a single, unitary computer application that preferably utilizes two interfaces. The first interface is to a desktop environment through which a user develops chemometric models (e.g., builds new models or modifies existing models) using the application. The other interface is to the real-time process system through which the application obtains real-time spectral data from the materials being monitored (e.g. an API in a pharmaceutical manufacturing process). The computer application also (preferably in real-time) runs a chemometric model against those spectral data and predicts (preferably in real-time) a property or properties of the material. One of the benefits provided by the present invention is that a chemometric model can be developed directly with coordinated software from spectral data obtained from the material that the user wants to monitor. In this fashion the model is more closely customized or tailored to the material to be monitored than a model developed according to past practices.

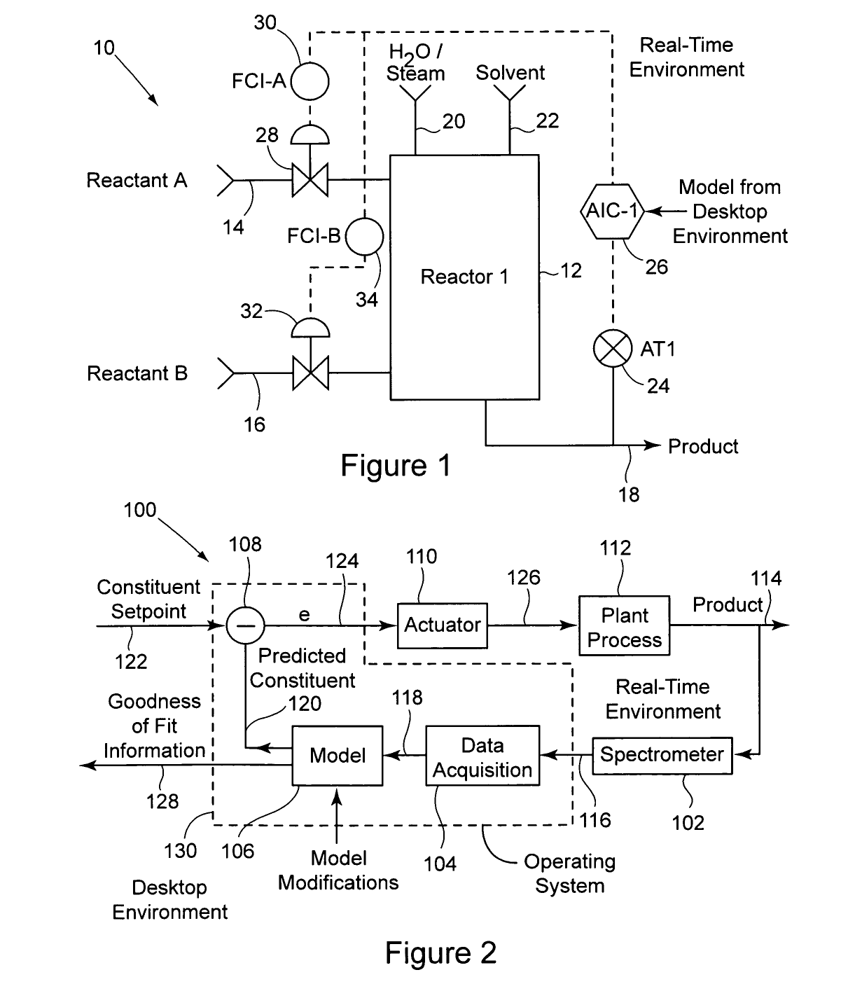

Referring to the accompanying drawings in which like reference numbers indicate like elements, FIG. 1 illustrates a material process system 10 constructed in accordance with the principles of the present invention. The exemplary process system 10 includes a reactor 12, a reactant source 14, a second reactant source 16, a product discharge 18, and typically a source of water 20 or other solvent 22 for flushing and cleaning the system 10. The reactants 14 and 16 flow into the reactor 12, mix and react within the reactor, and flow from the reactor as the product material 18. As is well known in the art, the operation of the process system 10 is greatly improved with closed loop control. Thus, the system 10 usually includes a control loop with a sensor 24, an analyzer or controller 26, and one or more pairs of control members (e.g. valves) 28 and 32 along with the controllers 30 and 34 associated with the valves 28 and 32. All of these devices are typically interconnected as shown. In operation, the sensor 24 senses the composition (or other property) of the product 18 and transmits a signal representing the composition to the analyzer or controller 26. The analyzer 26 sends an error signal, which depends on the property's deviation from a desired set-point, to the valve controllers 30 and 34. The error signal causes the valve controllers 30 and 34 to reposition the valves 28 and 32 respectively. In turn, the amount of reactants 14 and 16 flowing into the reactor 12 converge on the amounts required to produce the product 18 in conformance with the desired set-point.

In many instances, the process system 10 must be cleaned to preserve the process system in a desired cleanliness level (e.g., a desired sterile, sanitary, and an impurity-free condition). For instance, if the reactor 12 is a batch reactor, it may be necessary to thoroughly remove the products (and byproducts) of one batch before beginning the next batch (which may be for a product 18 having a different formulation than the previous batch). Thus, many process systems re-circulate the water or solvent to clean and flush the process system. One common way to determine when the cleaning cycle is complete is to monitor the cleaning fluid for the presence of the product. When the product concentration falls below a pre-determined level, the reactor 12 is considered to be clean. Upon finishing the cleaning cycle, though, residual cleaning fluid may be present in the reactor 12. Further, for closed loop control of the system 10, it is necessary to know the concentration of the product (e.g. an active pharmaceutical ingredient or API) and other chemicals in the process system 10. This need arises because, as the reaction begins, proceeds, and completes, the concentration of the product and other materials will vary.

As will be appreciated by those skilled in art, the process system 10 is not limited to the production of pharmaceuticals. Further still, process system 10 need not even include a reactor. Process system 10 need only be a system that performs one or more processes on a material. For instance, the process system could be a transport system (e.g. a pipeline) or even a product drying system. Thus, the scope of the present invention is not limited to the exemplary process system 10 shown in FIG. 1.

Nonetheless, as stated previously, it is often desired to determine the composition of the material in the system 10 including the concentration of one or more constituents of the material or product. Often one or more spectrometers are used as the sensor 24 to determine the material composition. Theoretically, each chemical produces a unique spectrum that identifies the chemical even if the material is present in low concentrations. Of course, the spectrum associated with the product 18 is a combination of the individual spectra of all of the chemicals present. The analyzer 26 of the preferred embodiment includes an integrated computer application that allows the user to analyze spectra, develop chemometric models, and to monitor or even control the process system 10. Additionally, this integrated computer application preferably includes a plurality of graphic user interfaces (GUIs) which allow the user to perform these operations in one seamless, integrated environment. Further still, in a preferred embodiment, the analyzer 26 is a personal computer.

With reference to FIG. 2, a closed-loop control system 100 is shown in block diagram form. The control loop 100 can be used for controlling process systems such as those shown in FIG. 1. The control loop 100 includes one or more spectrometers 102, a data acquisition device 104, a chemometric model 106, a comparator 108, and one or more actuators 110 that interface the control loop 100 to the plant process 112 (e.g. the process system 10 of FIG. 1). These components are interconnected as shown in FIG. 2. In real-time, the spectrometer 102 measures spectra of the material in the process system and transmits a signal 116 that is representative of those spectra to the data acquisition device 104. The chemometric model 106 receives the signal 116 from the data acquisition device 104 and predicts one or more properties 120 (e.g. the concentration of a constituent in the process material) of the process material from the signal 118 representing the spectra. Additionally, the chemometric model 106 may also produce goodness of fit information 128 with which the user can evaluate the performance of the chemometric model 106 in predicting the property 120. In turn, the comparator 108 compares the property 120 of the process material to a set-point 122 that is preferably supplied by the user. From the set-point 122 and the property 120 of the material (or rather the signal representing that property), the comparator generates an error signal “e” to drive the actuator 110. Changes in the output of the actuator 110 that are driven by the error signal “e” then affect the process system in a manner that is pre-selected to drive the error signal “e” to zero. Thus, the model 106 can be employed in real-time to control a process system 112. In addition, the user can modify the model 106 by inputting changes. Of course, the modifications may include the initial operations necessary to build a new chemometric model 106.

Furthermore, as shown in FIG. 2, a single, unitary, computer application 130 is supplied by the current embodiment. The application 130 has two interfaces. One interface is to the real-time environment and includes an input for receiving the signal 116 that represents the spectra being sensed by the spectrometer 102. The real-time interface can also include an input for receiving the set-point 122 and an output for transmitting the error signal “e.” The other interface is to the desktop environment wherein the user can evaluate the chemometric model 106 using, inter alia, the goodness of fit information 128 supplied at the desk top environment, and the predicted properties 120 of the process material, and compare these to the analytically determined measurements of the property 120 of the process material. If desired, the user can also modify (or build) the chemometric model 106 using the interface of the application 130 to the desk top environment.

Previously, the chemometric modeling activities occurred in one application and the real-time predictions of the property of the process material occurred in another application and in another computer, or system. Because one application was used to perform the chemometric modeling and another application (and system) was used to predict the property of the process material, subtle variations arose between the manner in which the model predicted the property while under development (in a desktop environment) and the manner in which the model actually predicts the property (once imported into the real-time environment). As a result of these subtle variations, chemometric models built with previously available systems often proved to be less accurate than indicated by tests of the chemometric model while still in the desk top, development environment. Thus, once deployed in the real-time environment, these chemometric models delivered disappointing real-time performance in predicting the properties of the process material. In view, of these inaccuracies, the present invention provides a single, unitary computer application with an interface to the real-time environment and another interface to the desk-top environment thereby eliminating the source of these subtle variations that give rise to the inaccuracies.

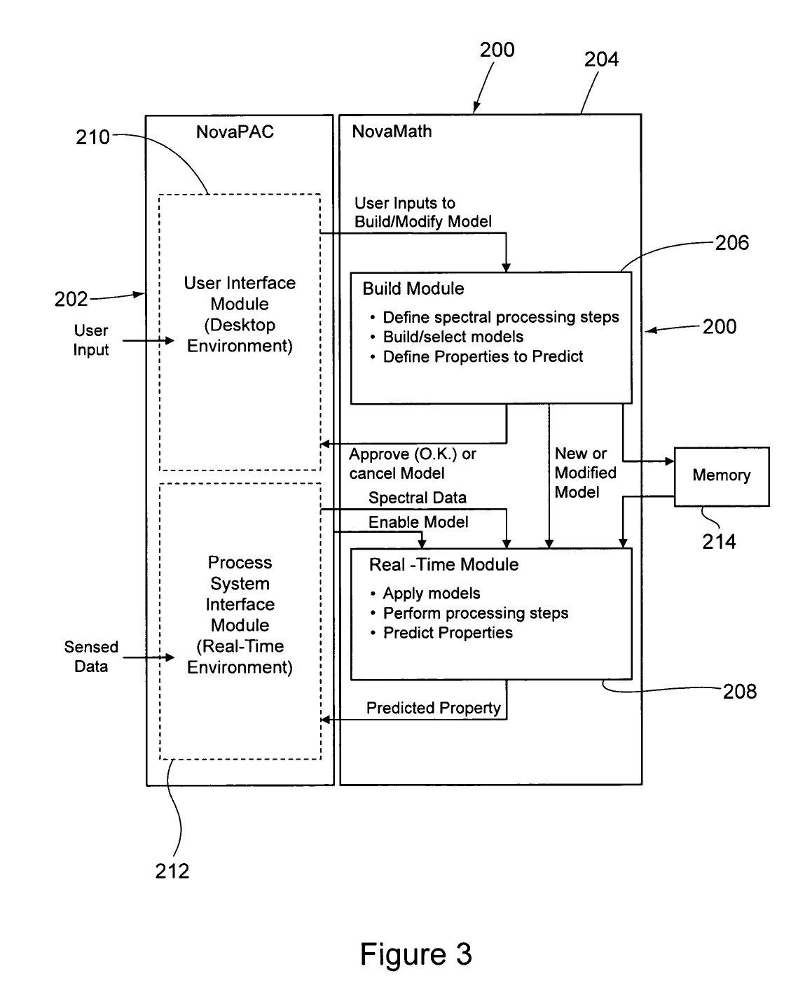

Turning now to FIG. 3, a top-level block diagram of an exemplary computer application 200, or program, that is structured in accordance with the principles of the preferred embodiment is illustrated. The exemplary application 200 preferably comprises an interface application 202 and a chemometric model development and execution application 204. The chemometric model development and execution application 204 preferably performs processing tasks such as building chemometric models and applying those models to sensed spectral data. The interface application 202 preferably interfaces the chemometric modeling application 200 with the user and with the incoming spectral data (such as the data that would be sensed by sensor 24 in system 10 of FIG. 1). While the exemplary application 200 is shown in FIG. 3 as relying on two applications 202 and 204 to handle the interfacing and processing tasks respectively, the application 200 could combine the tasks of applications 202 and 204 into a single application without departing from the scope of the present invention.

In a preferred embodiment, the interface application 202 and the chemometric model development and execution application 204 are, respectively, the NovaPAC and the NovaMath applications that are available from SpectrAlliance, Inc. of St. Louis, Mo. Furthermore, the interface and chemometric modeling applications 202 and 204 may be configured to be installed in, and run concurrently on, a Windows NT, Windows 2000, Windows XP personal computer or equivalent environment.

Interface Application 202:

Interface application 202 preferably comprises a user interface module 210 and a process system interface module 212.

The user interface module 210 preferably serves as a desktop environment on a user's computer that enables the user to access and execute the chemometric model development and execution application 204. The interface application 202 is preferably in communication with the chemometric model development and execution application 204 via any known data communication technique(s), including but not limited to direct communication and communication via a network such as an intranet, the Internet, a wireless network, or the like. An interface application 202 that is suitable for use with the preferred embodiment is the NovaPac application available from SpectrAlliance, Inc. of St. Louis, Mo. The interface application is preferably configured to accept any conventional signal from a spectrometer that conveys the spectral data gathered by the spectrometer. Furthermore, the interface application is preferably configured to output a conventional output signal indicative of the predicted property (e.g. a 4-20 milli-amp signal).

Chemometric Model Development and Execution Application 204:

The chemometric model development and execution application 204 preferably comprises a chemometric model building module 206, a real-time module 208, and a memory 214. The memory 214 is preferably an external memory and includes capacity to store a library of chemometric models from which the user can select one, or more, for evaluation, further development, or use in predicting real-time properties. The build module 206 also preferably communicates with the user interface module 210 within the interface application 202 in a bi-directional manner. From the user interface module 210, the build module 206 receives user inputs to develop (e.g. create, build, modify or edit) chemometric models. In return, the build module 206 transmits to the user interface module 210 information relevant to the models available for development and details regarding the models themselves. At any time, the user can save a model to the memory 214 or access a model in the memory 214. Thus, the memory 214 can hold a library of models. The user can also indicate, via the user interface module 210, which model to pass to the real-time module 208.

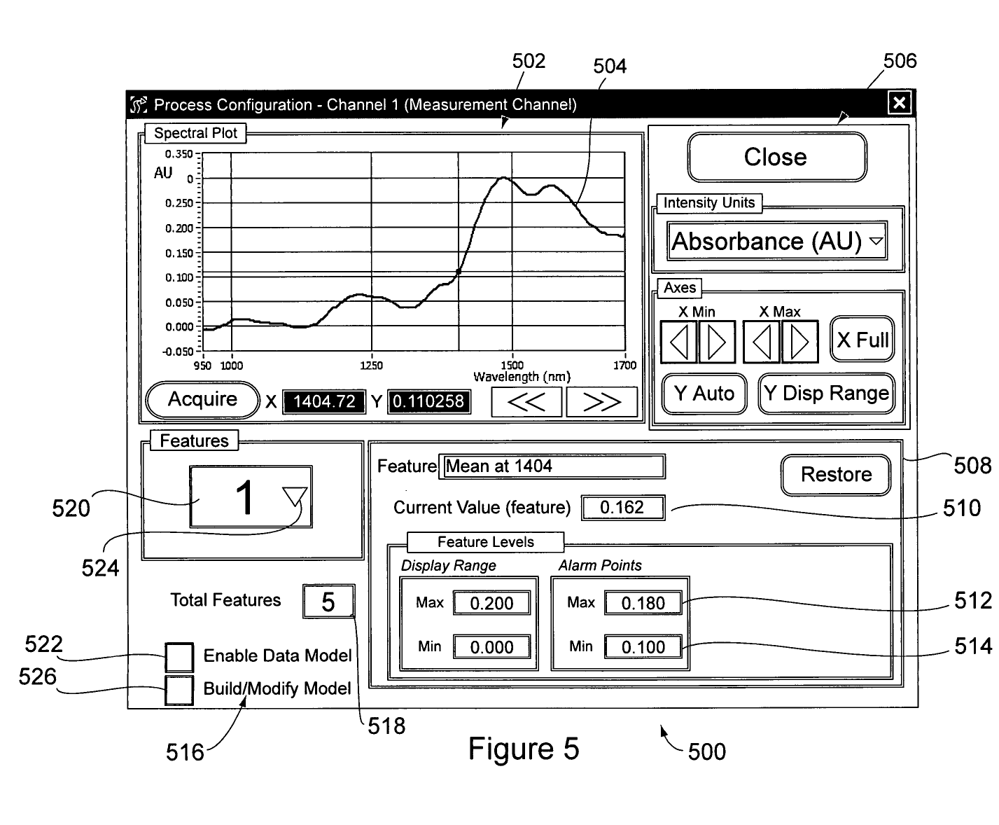

Turning now to the real-time module 208, the real-time module 208 also communicates bi-directionally with the interface application 202 and, more particularly, with the process system interface 212. In addition, the real-time module 208 receives chemometric models from either the build module 206 or the memory 214. The module 208 accepts the model, or otherwise accesses the model, and uses it to monitor and, perhaps, control a real-time system such as process system 10 of FIG. 1. To do so, the module 208 accepts, preferably in real-time, a sensed spectra (or spectrum) from the process system 10 via the process system interface 212. The module 208 applies the selected chemometric model to the spectra (i.e. processes the spectra in accordance with the model) and generates a prediction of the property(s) of the material for which the model was developed. In embodiments wherein the process system is to be controlled in response to the prediction, the real-time module 208 preferably also outputs the prediction of the property (e.g. the concentration of an API) to the process system interface 212. The real-time module 208 also generates data for display to the user via the interface application 202 so that the user is supplied with data concerning the real time process system (e.g. the current spectra from the real-time process system and other data discussed with reference to FIG. 5).

Preferably, the application 204 also provides to the user indicators of how well a particular spectrum “fits” the set of spectra used to build the model (the calibration set). These indicators are available as outputs of the model, and can be handled just like the model's predicted property value(s) (e.g., the concentration of one, or more constituents of the monitored material. For example, for partial least squares models, the application 204 preferably provides two goodness of fit indicators (Mahalanobis distance and X-residual standard deviation). For simple linear regression and multiple linear regression models, the user can use the predicted value of the property itself, which should be within the range of known values for the calibration set, to judge how well the model is performing.

A suitable chemometric model development and execution application 204 is the NovaMath application available from SpectrAlliance, Inc. of St. Louis, Mo. Enclosed herein as Exhibit A is a User Guide for the NovaMath application. This user guide provides a person skilled in the art with detailed information on how to make and use application 204 and the related GUIs described hereinafter.

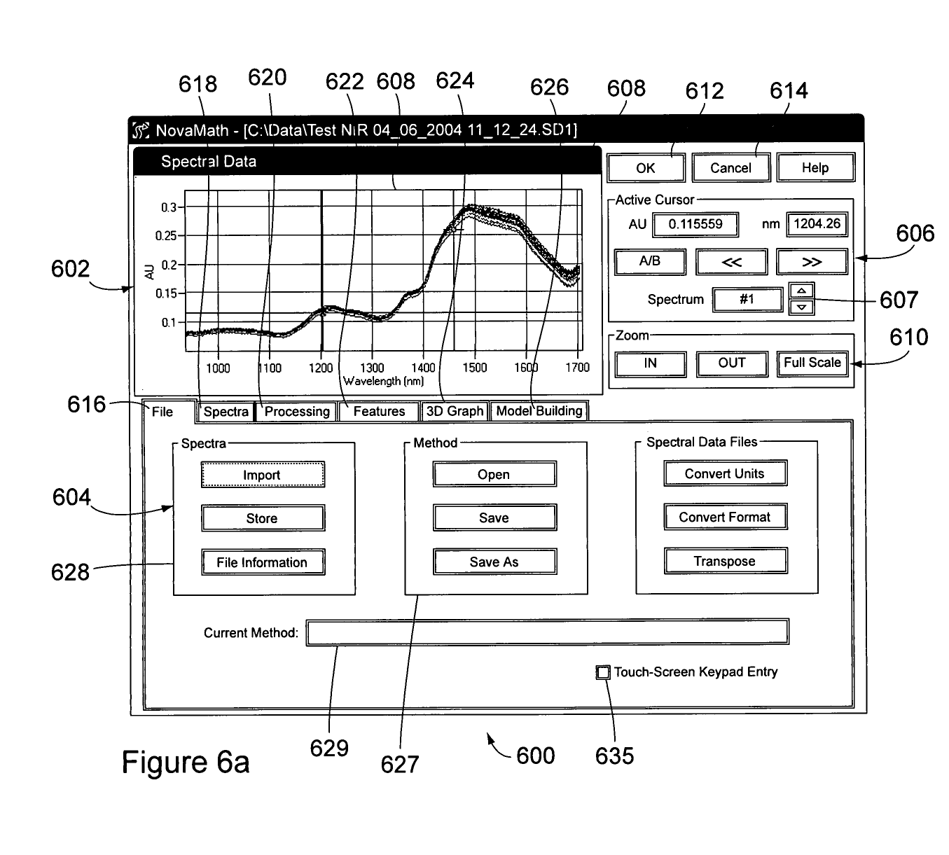

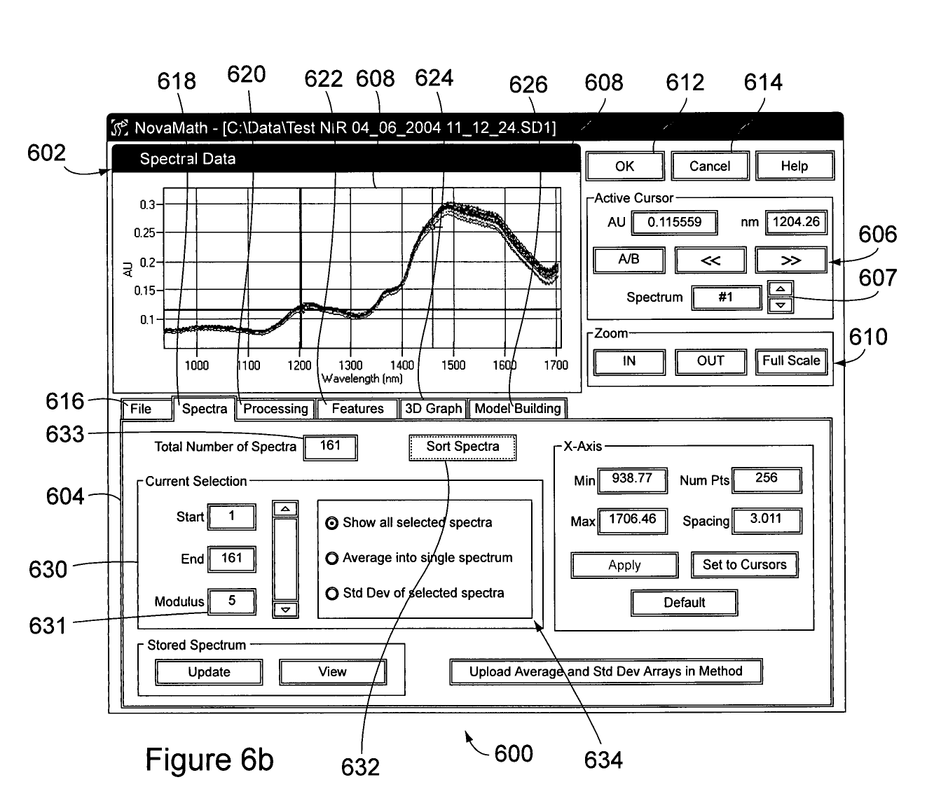

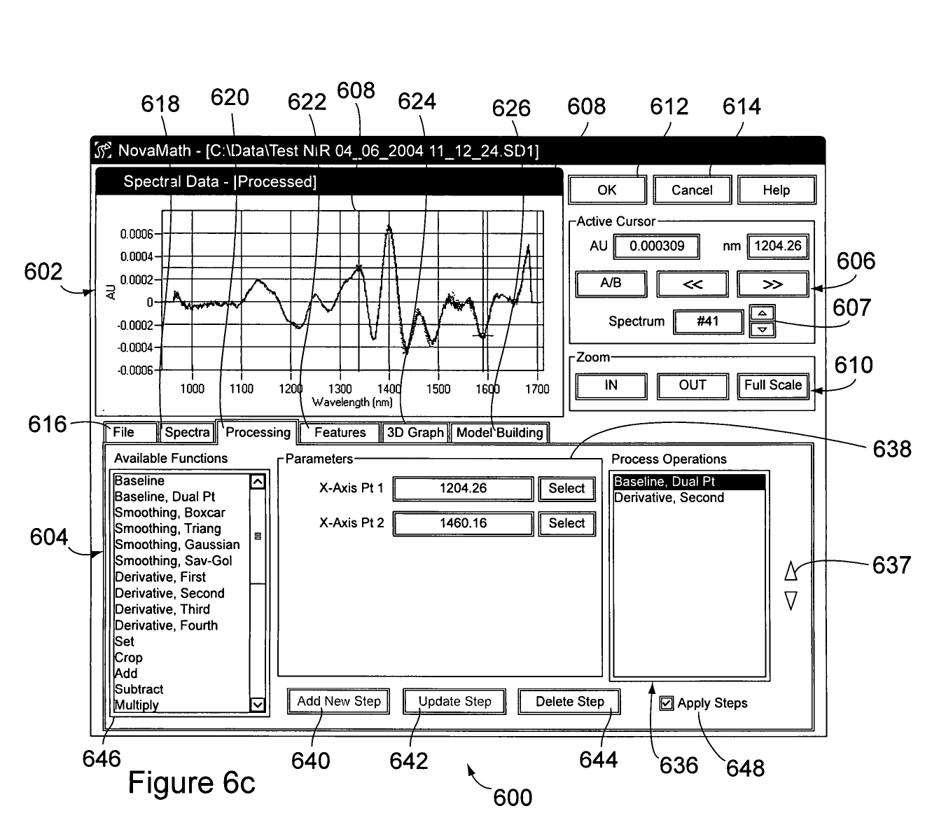

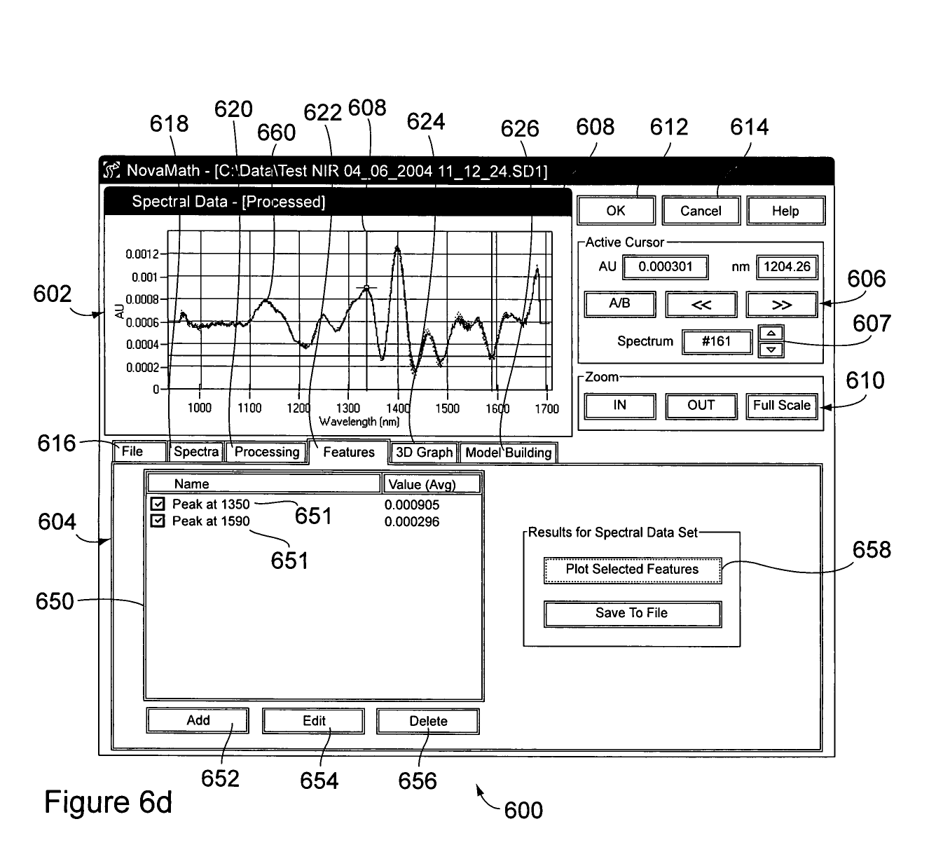

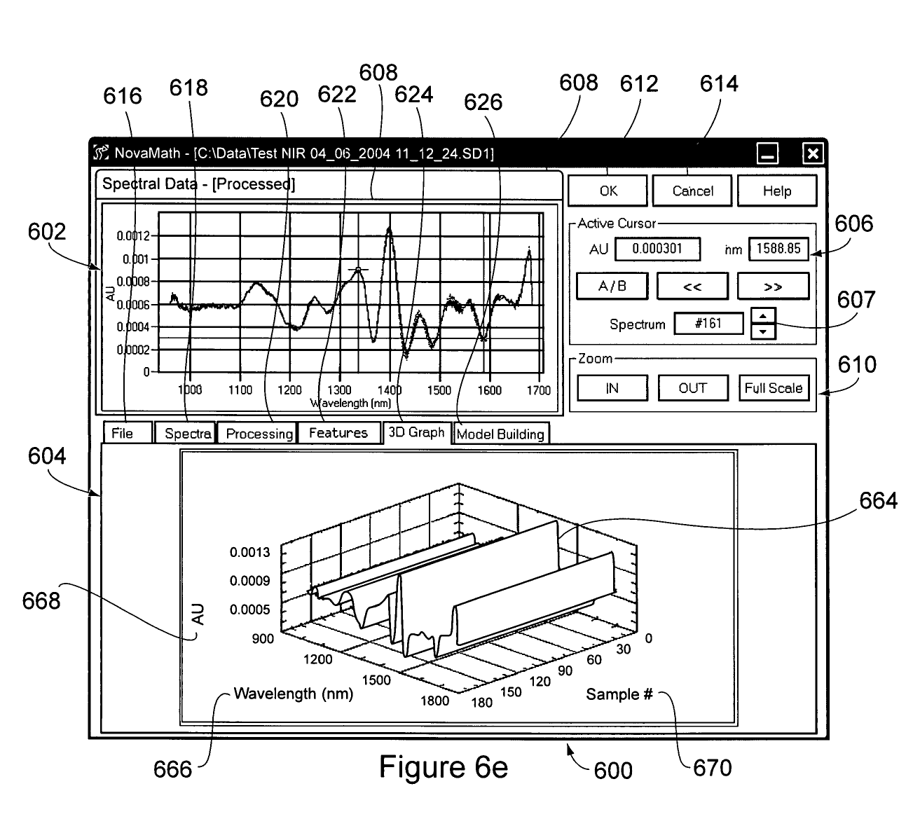

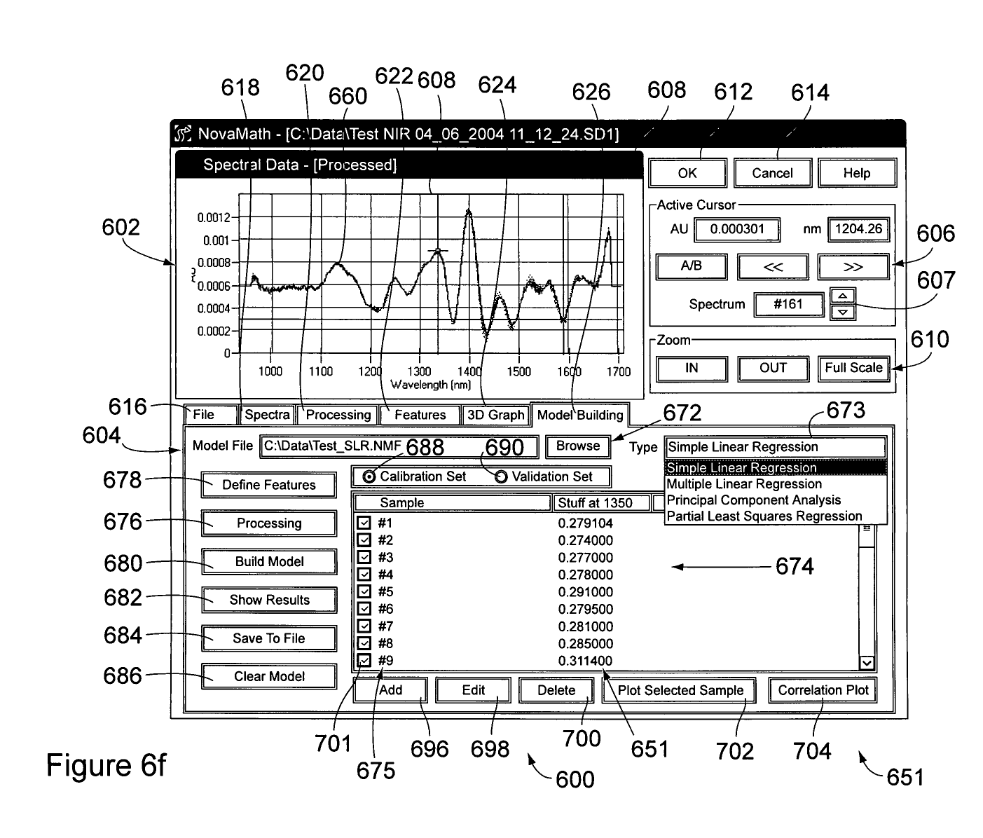

FIGS. 5 and 6a to 6f illustrate exemplary graphic user interfaces (GUIs) associated with the applications 202 and 204 of FIG. 3. Generally, FIG. 5 shows a preferred GUI 500 built and stored with the real-time module 208 of FIG. 3, whereas FIGS. 6a to 6f show preferred GUIs 600 built and stored with the build module 206 of FIG. 3. Because the modules 206 and 208 are integrated, the GUIs of FIGS. 5 and 6a-f provide the user with seamless access to the full functionality provided by the application 200. Additionally, navigating between the GUIs 500 and 600 may be accomplished without opening, or executing, another application. Further, while data and models may be imported from (and exported to) other applications, the program 200, via the GUIs of FIGS. 5 and 6a-f, provide the user all of the functions needed to analyze spectral data, to build and modify models, to predict properties by running a model, and to monitor and control process systems.

Turning now to FIG. 5, a preferred GUI 500 for interfacing the user with the real-time module 208 is illustrated. The majority of the real-time GUI 500 is associated with the functions provided by the real-time module 208 (of FIG. 3). The real-time GUI 500 includes a viewing area 502 that displays the real-time spectral plot 504 of the monitored material. The spectral plot represents the spectra that are obtained from a spectrometer that monitors the material in a process system such as the process system 10 shown in FIG. 1. The spectral plot is a measure of, preferably, the absorption of electromagnetic radiation (e.g. near infrared light) as it passes through the process material and is gathered by the spectrometer. As shown, the spectral plot indicates that the process material absorbs the radiation at some wavelengths more than it does at other wavelengths. The spectral plots may also measure light that is reflected from a sample and then gathered by the spectrometer, as is known in the field of spectroscopy. The resulting shape of the spectral plot is thus indicative of the material in the process system at the time that the spectra are obtained. From the plot, it is therefore possible to determine the properties of the process material. The real-time GUI 500 also includes another area 506 that contains several controls (e.g. buttons) used for providing the user flexibility in viewing the spectral plot 504 (e.g. zoom and scroll controls).

Additionally, the real-time GUI 500 includes a process control display area 508. Process control display area 508 includes a field 510 for displaying the current value of a feature of the spectral plot 504 is provided. Area 508 also includes a pair of controls 512 and 514 to input high and low alarm set-points respectively. These alarm set points allow the user to cause the integrated application 200 of FIG. 3 to issue a notification, or alarm, should the predicted property deviate above the high alarm value or below the low alarm value. The GUI 500 also preferably provides another area 516 that includes set of controls that allow the user to utilize, modify or build chemometric models via the build module 206 of FIG. 3. The area 516 includes an indication 518 of how many features of the spectral plot(s) shown in the spectral plot display area are determined by the model, a control 520 that enables the user to select which one of those features will have a data value displayed in field 510, and a control 524 for user selection from among the plurality of features identified at 518. The features include, for example, local maxima, local minimum, and rates of change with respect to the x-axis for the selected spectra. Area 516 also includes control 522 to allow the user to enable (and disable) the current model so that the model may in effect be turned “on” and “off.” Push button control 526 causes a GUI 600 (see FIGS. 6a to 6f) associated with the development module 206 to appear so that the user can study, modify, or build the chemometric models stored in the memory 214 of FIG. 3.

As shown by FIGS. 6a to 6f, the current embodiment also provides GUIs 600 for interfacing the user with a full suite of model development functions. The model development GUI 600 includes two general display areas. The first display area 602 includes a variety of controls for viewing selected spectra within plot area 608. The spectra displayed in the plot area 608 are those from which the user will choose for incorporation into a given chemometric model. Preferably, the displayed spectra are gathered from the spectrometer monitoring the process system (as shown in FIGS. 1 or 2). Preferably, each spectrum has associated with it an analytically determined value of the property for which the chemometric model is being built to predict. Thus, these spectra along with the analytically determine property values allow the user to develop an accurate chemometric model (for use in real-time) without the inaccuracies associated with building the chemometric model in one environment (i.e., the desk top environment) and using it to predict the property in another environment (i.e., the real-time environment). The second display area 604 includes a variety of controls for building and/or modifying (i.e. developing) models.

More particularly, the first display area 602 includes a set of controls 606 for setting the position of the cursor in the plot area 608. In addition the cursor may be moved to various sample spectra displayed in the plot area 608 with control 607. The user's actions in the second display area 604 may also alter the sample spectra displayed, as will be described subsequently. The first display area 602 also includes controls 610 that allow the user to zoom in on, and zoom out from, the sample spectra displayed in the plot area 608. The first display area 602 of the current embodiment also includes a control 612 for approving modifications made to the model (via the controls provided in the second display area 604). Likewise, the first display area 602 includes a control 614 for canceling modifications made to the model. Note that clicking on one of the controls 612 or 614 will cause the GUI 600 to close (or go to the background of the computer display) and the real-time GUI 500 (see FIG. 5) to come to the foreground of the computer display. It is worth noting that switching between GUIs 500 and 600 may be accomplished via other ways known in the art, for example via any number of known window navigation techniques that are widely available in a desktop PC environment.

Second display area 604 includes a plurality of selectable tabs that allow the user to navigate between various displays associated with developing chemometric models. The selectable tabs include a file tab 616, a spectra tab 618, a processing tab 620, a features tab 622, a 3D graph tab 624, and a model building tab 626. When the user selects one of the tabs, additional controls are displayed according to the tab selected. The GUI 600 of FIG. 6a details area 604 when the file tab 616 has been selected. The GUI 600 of FIG. 6b details area 604 when the spectra tab 618 has been selected. The GUI 600 of FIG. 6c details area 604 when the processing tab 620 has been selected. The GUI 600 of FIG. 6d details area 604 when the features tab 622 has been selected. The GUI 600 of FIG. 6e details area 604 when the 3D graph tab 624 has been selected, and the GUI 600 of FIG. 6f details area 604 when the model building tab 626 has been selected.

As will be appreciated by those skilled in the art, the user will progress generally in order across the tabs 618, 620, 622, 624, and 626 during the course of building a model. However, the user is not restricted to a particular order, or even one pass through the tabs. Rather, it will be understood that a user can progress through one or more of the tabs in any desired sequence. Thus, generally a user will select a file of spectra using tab 616 and select spectra via tab 618. Using the processing tab 620, the user defines the processing to be performed on the selected spectra. Further, the user can define the features to be included in the model using the features tab 622. Model building tab 626 allows the user to finalize the building of the model while the 3D graph tab 624 allows the user to view the sample spectra at any time that it may be beneficial to analyze the spectrum (e.g. while building the model).

With reference now to FIGS. 6a and tab 616 in particular, selection of the file tab 616 provides controls 628 for importing and storing new sample spectra from external data sources (e.g. spreadsheets, files with proprietary formats that are associated with the various spectroscope suppliers, or their equivalents). The user may also obtain information concerning the types of formats that the sample spectra are stored in by selecting the “File Information” button of control 628. Selection of the file tab 616 also allows a user to perform a computer operation (e.g. the methods of “opening”, “saving”, or “saving as”) on chemometric model files via controls 627 with the path and file name being indicated in the current method field 629. Also shown is a button 635 that when selected causes a pop up keyboard window to appear so that, if the application is run on a computer with a touch screen, the user can enter text and numeric values via the pop up keyboard. Thus, the models manipulated in accordance with the principles of the present invention are not limited to spectral files created with any particular proprietary application.

User selection of the spectra tab 618 causes the GUI of FIG. 6b to appear, thereby providing the user with access to still other controls for viewing selected spectra (which are displayed in the spectral plot area 608) from the set of spectra associated with samples of the monitored material. Area 604 of FIG. 6b preferably includes a set of controls 630 that allow the user to select a range of spectra from those stored in the currently selected file. The total number of these spectra is identified in field 633. Further, the spectra selection controls 630 allow the user to select a set of spectra (e.g. every fifth spectra) via the “modulus” input control 631. Control 634 determines how spectral data are displayed in plot area 608. Area 604 of FIG. 6b preferably also includes a control 632 to allow the user to sort the spectra by a variety of criteria (including the features 651 that will be discussed with regard to FIG. 6d). Used in conjunction with the range controls 630, the sort control 632 allows the user to sort the sample spectra based on criteria and select those with the highest, lowest, or some intermediate ranking according to the criteria. Thus, for example, the user can select those sample spectra with the highest value for the property to be predicted and include only these spectra in the chemometric model. Also, the spectra tab 618 causes the selected spectra to be displayed in the plot area 608. The user may also alter how the plot area 608 displays the spectra via the control 634.

FIG. 6c details area 604 when the processing tab 620 has been selected. More particularly, the area 604 of FIG. 6c preferably includes several controls 636, 638, 640, 642, 644, 646, and 648. The list control 636 includes an ordered list of operations (that together define a process to be performed on the selected sample spectra). Area 604 of FIG. 6c preferably also includes controls to add operations to, update operations in, delete operations from, or change the order of operations in the operation list 636 (controls 640, 642, and 644 respectively). More particularly, by selecting an operation in the list 636 and then selecting the order control 637, the user can move an operation in the ordered list 636 up or down in the order. As the user builds the list of operations 636, the user can select the function(s) to be performed on the sample spectra from the list 646 of available functions. If a function selected from list 646 requires the user to enter a parameter(s) to define the particular function selected, the processing tab 620 also displays controls 638 to allow the user to enter the required parameter(s). Once the user completes the operations list 636 (or at any time during the creating of the list), the user can apply the list of operations 636 to the selected spectra and view the results via the control 648 that causes the display area 608 to be updated with plots resulting from the listed operations. Thus, area 604 of FIG. 6c allows the user to define the operations to be performed on the selected sample spectra. These processes may be used to define features 651 (see FIG. 6d) that will be discussed in more detail below.

FIG. 6d details area 604 when the user has selected the features tab 622. This area includes a list 650 of features 651 (e.g. calculated values) of the selected spectra 660 (that is displayed in the plot area 608 above). The features 651 may be associated with any combination of the selected spectra, the chemometric model, or the spectra arising from the monitored material depending on which features and which spectra or model the user has selected. For example, the user can define a goodness of fit indication (e.g. Mahalanobis distance or X-residual standard deviation for partial least squares models) as a feature. Controls 652, 654, and 656 allow the user to add, edit, and delete respectively the features 651 in the features list 650 by selecting one, or more, of the listed features with (preferably) a pointing device like a mouse and clicking on the appropriate control 652, 654, or 656. The user can also indicate, via the checkbox associated with each feature 651 (e.g. the peak at 1350), which features will be made available for real-time display in field 510 of FIG. 5. Note, that the display area 508 of FIG. 5 can be expandable to display more than one feature 651 as indicated by the user's selections. Control 656 offers for selection a list of mathematical functions that enable the user to best monitor the process materials. Meanwhile, control 658 allows the user to plot the features 651 in the plot area 608 as they are being defined. Typically control 658 enables the user to view the changes in feature 651 across successive spectra, as for example, as a function of time as the process continues. These features 651 enable the chemometric model to correlate the monitored spectrum with the property of interest (e.g. the concentration of an impurity) in accordance with the users choices in developing the chemometric model.

FIG. 6e displays area 604 when the 3D graph tab 624 has been selected. FIG. 6e shows that the user may view and analyze the 3 dimensional graph 664 of the sample spectra. The axes of the 3 dimensional graph 664 may include the wavelength 666 of the light, the intensity of the radiation absorption 668, and the sample spectra number 670. The graph 664 therefore allows the user to visually identify trends and correlations, especially when used in conjunction with the sort control 632 (of FIG. 6b). Thus, the 3D tab 624 provides a convenient way for the user to analyze the sample spectra while building the model.

FIG. 6f details area 604 when the model building tab 626 has been selected. Area 604 of FIG. 6f includes a set of controls 672 for either choosing a chemometric model in a pre-existing file or creating a new model. Area 604 of FIG. 6f also includes controls for the following operations:
drop down list 673 for selecting the type of model to create (e.g. simple linear regression),
list box 674 for selecting sample spectra for inclusion in the model (see FIG. 6b),
list 675 of the selectable sample spectra and the corresponding values of the feature 651.
Note that a “dummy” feature 651 is listed and labeled as “Stuff at 1350 (nanometers)” for each selectable spectra,
button 676 which causes the processing tab 620 to be displayed for defining the processing to be associated with the selected spectra
button 678 for defining the features 651 (see FIG. 6d) of each of the processed spectra via the features tab 622 which is displayed when the user selects the button 678, button 680 for causing the chemometric model build module 206 (see FIG. 3) to build the chemometric model (e.g. incorporating the results of the foregoing operations in a new, or modified, model)
button 682 for using the new (or modified model) to show the plots or tabular results related to the particular type of model that was previously selected with model type control 673,
control 684 for saving the current model to a file, and
control 686 for clearing the current model if the user so desires.

Further area 604 of FIG. 6f provides the user with the ability to select for display and editing in list 675, the spectra associated with the model's calibration set or validation set. This selection is made using either the calibration set control 688 or the validation set control 690. Area 604 of FIG. 6f also includes the following controls:
button 696 for adding sample spectra to the calibration set or validation set as shown in list 675,
button 698 for editing attributes of a selected sample spectrum and its feature 651, such as the feature 651 value or the sample name,
button 700 for deleting a particular spectra from either the calibration set or the validation set,
checkboxes 701 for indicating whether the sample will be included in the next build of the model (or the next validation operation of the model),
button 702 for plotting the selected sample spectra in the plot area 608 of the first display area 602, and
button 704 for displaying a plot of the correlation coefficient of a selected feature.

Thus, the present invention provides integrated GUIs that include the real-time GUI 500 of FIG. 5 and the model development GUI 600 of FIGS. 6a to 6f, the GUI 600 including viewing areas 604 associated with the selectable tabs 616, 618, 620, 622, 624, and 626 that allow the user to build and modify chemometric models while also allowing the user to analyze the model and related spectra, data, and information. Because the application provides integrated GUIs, the user is provided with a user friendly, flexible, and integrated environment in which to develop and run models for the underlying process system (e.g. system 10 of FIG. 1).

In any case, the integrated application 200 (of FIG. 3) provides a seamless environment for users to both develop and apply chemometric models. By providing the user with a single unitary engine to both develop and run chemometric models, the present invention reduces the amount of time it takes for a modeler to learn both tasks. Additionally, because the models need not be imported, or otherwise transferred from model development software to a separate platform's model application software (or vice versa), the present invention streamlines the model development and application process. Moreover, both processes (model development and application to a real-time system) can be run concurrently by the user. Thus, the real-time system 10 need not be idled during the development of a new, or improved, chemometric model. Moreover, by allowing the user to build or modify a chemometric model and run the model in the same processing environment, the present invention eliminates the subtle differences that arise from performing these tasks in different computing environments.

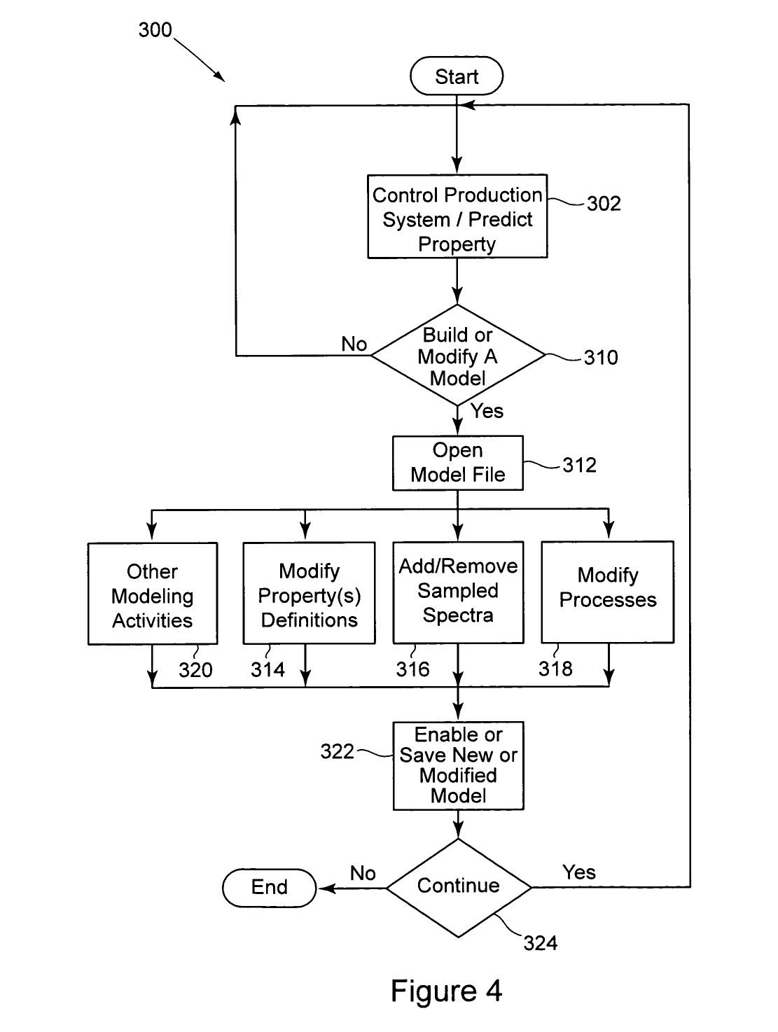

Having described the different components of the preferred embodiment, with reference now to FIG. 4, an exemplary method that is provided by this preferred embodiment is illustrated. In the method 300, a single, unitary program (such as the chemometric modeling application 200 of FIG. 3) is used to monitor or control a real-time system (operation 302). At some time, in operation 310, the user may desire to either build or modify a chemometric model. If so, the method 300 continues in operation 312. Otherwise, the method 300 continues with the monitoring of the system in operation 302. Assuming that the user wishes to develop a model, at operation 312, the user accesses the file in memory that defines the model or creates a new file. Using the GUIs of FIGS. 6a-f to access the model development capabilities of application 204, the user develops the chemometric model by performing one or more of the following operations:
1. Modifying the property(s) to be predicted by the model (operation 314);
2. Adding or removing spectra from the model (operation 316);
3. Modifying the processes which the model performs on the spectra (operation 318); or
4. Other chemometric model development activities known in the art (operation 320).

When the user desires to save the current model, the method continues with the user doing so in operation 322. Of course, instead of merely saving the new, or modified, model the user can direct module 208 (of FIG. 3) to begin applying the model to the spectra gathered from the real-time system that is being monitored (see operation 322).

In view of the foregoing, it will be seen that the several advantages of the invention are achieved and attained. A user friendly, integrated application has been provided that reduces the time a required to build or modify chemometric models. Also, because all of the functions necessary to both develop chemometric models and to run the resulting models are provided in an integrated user environment, the “learning curve” associated with both tasks is lessened.

The embodiments were chosen and described in order to best explain the principles of the invention and its practical application to thereby enable others skilled in the art to best utilize the invention in various embodiments and with various modifications as are suited to the particular use contemplated.

As various modifications could be made in the constructions and methods herein described and illustrated without departing from the scope of the invention, it is intended that all matter contained in the foregoing description or shown in the accompanying drawings shall be interpreted as illustrative rather than limiting. Thus, the breadth and scope of the present invention should not be limited by any of the above-described exemplary embodiments, but should be defined only in accordance with the following claims appended hereto and their equivalents.

What is claimed is:

1. A method for integrating chemometric model development and chemometric model application to a process system, the method comprising:
receiving spectral data from a process system, the received spectral data corresponding to a material being monitored by the process system;
receiving user input through at least one graphic user interface;
developing at least one chemometric model at least partially in response to the received user input; and
applying at least one chemometric model to the received spectral data to thereby predict a property of the material being monitored; and
wherein the developing step and the applying step are performed by an integrated software program.

2. The method of claim 1 wherein the spectral data receiving step comprises receiving the spectral data from the process system in real-time.

3. The method of claim 2 wherein the applying step comprises applying the at least one chemometric model to the received spectral data in real-time to thereby predict a property of the material being monitored.

4. The method of claim 3 further comprising:
controlling the process system at least partially in response to the predicted property.

5. The method of claim 4 wherein the controlling step comprises controlling an amount of the material being monitored that is introduced into the process system at least partially in response to the predicted property.

6. The method of claim 2 further comprising:
displaying at least one feedback graphic user interface on a user computer, the at least one feedback graphic user interface being configured to provide a user of the user computer with real-time feedback as to a quality of the at least one applied chemometric model.

7. The method of claim 6 further comprising:
displaying at least one chemometric model modification graphic user interface on the user computer, the at least one chemometric model modification graphic user interface being configured to receive input from the user that corresponds to a modification of the at least one chemometric model being applied to the received spectral data; and
wherein the user input receiving step comprises receiving chemometric model modification input from the user through the at least one chemometric model modification graphic user interface.

8. The method of claim 7 wherein the applying step further comprises, in response to user input, applying the modified chemometric model to the received spectral data to thereby predict a property of the material being monitored.

9. The method of claim 8 further comprising:
in response to user input, navigating the user between the at least one feedback graphic user interface and the at least one chemometric model modification graphic user interface.

10. The method of claim 2 further comprising:
retrieving from a memory at least one of a plurality of chemometric models that are stored in the memory; and
providing the at least one retrieved chemometric model to at least one of the group consisting of the developing step and the applying step.

11. The method of claim 2 wherein the developing step includes developing at least one new chemometric model at least partially in response to the received user input.

12. A system comprising:
a first interface for accepting a user input from a desktop environment;
a processor in communication with the first interface to build a first chemometric model using the user input from the desktop environment;
a second interface for accepting a spectral input from a real-time environment, the spectral input being representative of a material, the processor to predict a property of the material using the spectral input from the real-time environment and a second chemometric model; and
a memory in communication with the processor to store the first chemometric model and the second chemometric model.

13. The system of claim 12, wherein the user input is a selection of a sample spectrum.

14. The system of claim 12, further comprising a real-time process controller associated with the material and in communication with the second interface.

15. The system of claim 12, wherein the property is the concentration of a constituent of the material

16. The system of claim 12, wherein the first chemometric model has a first format, the computer further comprising a third interface for accepting a third chemometric model having a format that is different than the format of the first chemometric model.

17. A computer readable medium for integrating chemometric model development and chemometric model application to a process system, the computer readable medium comprising:
a code segment for execution by a processor and configured to receive spectral data, the received spectral data corresponding to a material being monitored by a process system;
a code segment for execution by a processor and configured to develop at least one chemometric model at least partially in response to user input received via at least one graphical user interface;
a code segment for execution by a processor and configured to apply at least one chemometric model to the received spectral data to thereby predict a property of the material being monitored.

18. The computer readable medium of claim 17 wherein the spectral data receiving code segment is further configured to receive the spectral data in real-time.

19. The computer readable medium of claim 18 wherein the chemometric model applying code segment is further configured to apply the at least one chemometric model to the received spectral data in real-time to thereby predict a property of the material being monitored.

20. The computer readable medium of claim 18 further comprising:
a code segment for execution by a processor and configured to display at least one feedback graphic user interface on a user computer, the at least one feedback graphic user interface being configured to provide a user of the user computer with real-time feedback as to a quality of the applied chemometric model.

21. The computer readable medium of claim 20 further comprising:
a code segment for execution by a processor and configured to display at least one chemometric model modification graphic user interface on the user computer, the at least one chemometric model modification graphic user interface being configured to receive input from the user that corresponds to a modification of the chemometric model being applied to the received spectral data.

22. The computer readable medium of claim 21 further comprising:
a code segment for execution by a processor and configured to, in response to user input, apply the modified chemometric model to the received spectral data to thereby predict a property of the material being monitored.

23. The computer readable medium of claim 22 further comprising:
a code segment for execution by a processor and configured to, in response to user input, navigate the user between the at least one feedback graphic user interface and the at least one chemometric model modification graphic user interface.

24. The computer readable medium of claim 18 wherein the chemometric model applying code segment is further configured to apply the at least one developed chemometric model to the received spectral data in real-time to thereby predict a property of the material being monitored.

25. The computer readable medium of claim 18 further comprising:
a code segment for execution by a processor and configured to (1) retrieve from a memory at least one of a plurality of chemometric models that are stored in the memory, and (2) provide the at least one retrieved chemometric model to at least one of the group consisting of the chemometric model developing code segment and the chemometric model applying code segment.
